(19) United States
(12) Patent Application Publication
(10) Pub. No.: US 2005/0031364 A1
(43) Pub. Date: Feb. 10, 2005

(54) Image forming apparatus using plural fixing means

(75) Inventor: Yasuhiro Hayashi, Ibaraki (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/902,153

(22) Filed: Jul. 30, 2004

(30) Foreign Application Priority Data
Jul. 31, 2003 (JP) 2003-205153

(51) Int. Cl. G03G 15/20

(52) U.S. Cl. 399/69; 399/341

(57) ABSTRACT

An image heating apparatus has a first pressure member contactable with a fixing member to form a first nip portion; a fixing temperature changing unit for changing a fixing temperature in accordance with a recording material; first power supply control unit for controlling the fixing temperature; an image heating member for heating an image and located on a downstream side of the fixing member; a second pressure member contactable with the image heating member to form a second nip portion, wherein a width of the first nip portion in the recording material conveying direction is larger than that of the second nip portion; a heating temperature changing unit for changing a heating temperature of the image heating member in accordance with a predetermined gloss of an image; and a second power supply control unit controlling the temperature of the image heating member.

### BACKGROUND OF THE INVENTION

1. Field of the Invention

The present invention relates to an image forming apparatus using an electrophotographic process which is generally provided with a fixing apparatus for fusing and fixing toner composed of a resin, a magnetic substance, a colorant, or the like to a transfer material electrostatically carrying the toner, by applying heat and pressure while the transfer material and the toner are nipped and conveyed at a press contact portion (nip portion) between a heating means (roller, endless belt member, or the like) and a pressurizing means (roller, endless belt member, or the like) that are rotated while being in press contact with each other. Further, the present invention relates to a fixing apparatus having an external heating means for heating the heating means while in contact with the heating means.

2. Related Background Art

Recently, various types of recording materials may be used in image forming apparatuses, and it is desirable that the image forming apparatuses can reproduce a wide range of gloss with respect to those recording materials. Accordingly, it is necessary for the image forming apparatuses to output images having a wide range of gloss from a low gloss to a high gloss. Further, the gloss of the final image depends greatly on a fixing means for fixing an unfixed image on an unfixed image on a recording material to the recording material by heat.

Fixing conditions and gloss are briefly explained here. With an image having a high gloss, a toner image on a recording material has a smooth surface, and diffuse reflection of light reflecting on the image is small, achieving the high gloss. With an image having a low gloss, a toner image on a recording material has a rough surface, and diffuse reflection of light reflecting on the image is large, resulting in the low gloss. To enhance gloss, toner is fused by heat to make its viscosity low at the time of separation, to thereby reduce the adhesion force between the toner and a fixing member. Thus, the smoothness of the surface of the toner image is increased. FIG. 5 shows a relationship between the fixing temperature and the gloss. In FIG. 5, the higher the fixing temperature is, the larger the degree of fusion of the toner becomes to lower the viscosity of the toner. As a result, because the toner having a low viscosity does not easily adhere to the fixing member at the time of separation, the surface of the toner image is smooth when the toner image is separated, making it possible to output an image having a high gloss. However, if the toner is fused too much, a high temperature offset occurs where portion of the fused toner adheres to the fixing member. As a result, the smoothness of the toner image conversely decreases, lowering the gloss. Further, the same holds true for a nip width. If the nip width is large, the amount of heat applied to the toner increases, and the viscosity of the toner becomes low. Therefore, a relationship is established between the nip width and the gloss which is similar to the relationship between the fixing temperature and the gloss. On the other hand, if pressure is applied to the toner image, a difference in height within the toner image becomes smaller by pressing the toner image, making the surface of the toner image smoother. Thus, the gloss can be enhanced. The pressure mentioned here is a nip pressure between a fixing roller and a pressure roller in a fixing means. The fixing means has a nip portion formed between the fixing roller and the pressure roller that is brought into press contact with the fixing roller and where a recording material is nipped and conveyed. FIG. 6 shows the relationship between the nip pressure and the gloss. As shown in FIG. 6, the gloss increases as the nip pressure becomes higher. However, there is a limit in decreasing the difference in height within the toner image by the nip pressure, and therefore the finally obtained gloss approaches a certain value.

In view of the above, in order to achieve a wide range of gloss with one fixing means, there is a method of changing the pressure and the fixing temperature.

However, the method of changing the pressure with high accuracy requires a complicated mechanical structure, and is not desirable because it lacks stability owing to durable use. On the other hand, the method of changing the fixing temperature in order to obtain a variety of gloss causes the following problems. That is, it is necessary to make the fixing temperature high to achieve a high gloss. However, if the fixing temperature is too high, when paper, especially coat paper with a coat having low air permeability formed on its surface, is passed through the fixing nip portion, moisture in the paper evaporates at once to become water vapor. The water vapor concentrates between the coat layer and the paper, and the coating layer becomes rough with blisters, causing image disturbance. Therefore, while it is possible to fix a toner image to a recording material by using one fixing means, it is difficult to output an image having a sufficiently high gloss.

Further, in the case of a structure employing a fixing apparatus including plural fixing devices as disclosed in Japanese Patent Application Laid-Open No. H7-311505, the following problems occur. This fixing apparatus is provided with two fixing means each having a fixing roller including a halogen heater, and a pressure roller (in the description below, as appropriate, a distinction is made between the terms fixing means and the fixing apparatus: the fixing means includes a pair of heating member and a pressure member, and the fixing apparatus includes plural fixing means). The fixing means are provided on an upstream side and a downstream side, respectively, in a conveying direction of the recording material (such as paper or a transparent sheet). As for the fixing means on the upstream side (first fixing means), a fluororesin surface of a surface layer of the fixing roller is smoothed to a surface roughness of no more than 1 μm in ten-point height of irregularities Rz so that toner does not easily adhere thereto. As for the fixing means on the downstream side (second fixing means), the fixing roller has a relatively rough surface so that its surface roughness is approximately 1 to 50 μm in ten-point height of irregularities Rz, in order to reduce the gloss. This aims at suppressing the gloss of the image in an image forming apparatus for black and white printing.

With this method, however, if an image having a high gloss is to be output by using coat paper, it is necessary to raise the fixing temperature in order to obtain a sufficiently high gloss with the first fixing means, causing blisters on the coat paper. Therefore, the similar problems occur even with the structure including plural fixing means.

Accordingly, a structure including plural fixing means is required by which a wide range of gloss is achieved with respect to various types of recording materials without causing blisters on the coat paper that has absorbed moisture.

### SUMMARY OF THE INVENTION

An object of the present invention is to prevent abnormality from occurring at the time of fixing on a surface of coat paper that has absorbed moisture, and to achieve a wide range of gloss with respect to various types of recording materials.

Another object of the present invention is to provide an image heating apparatus, including: a fixing member for heat-fixing an unfixed toner image on a recording material; a first pressure member that is brought into press contact with the fixing member and forms a first nip portion where the recording material is nipped and conveyed; a fixing temperature changing unit for changing a fixing temperature of the fixing member in accordance with the recording material; first power supply control unit for controlling the fixing temperature of the fixing member so as to become the changed fixing temperature; an image heating member for heating an image on the recording material, the image heating member being located on a downstream side of the fixing member in a conveying direction of the recording material; a second pressure member that is brought into press contact with the image heating member and forms a second nip portion where the recording material is nipped and conveyed, wherein a width of the first nip portion in the conveying direction of the recording material is larger than that of the second nip portion; a heating temperature changing unit for changing a heating temperature of the image heating member in accordance with a predetermined gloss of an image; and second power supply control unit for controlling the heating temperature of the image heating member so as to become the changed heating temperature.

Further objects of the present invention will become apparent from the description below.

### BRIEF DESCRIPTION OF THE DRAWINGS

FIG. 1 is a longitudinal sectional view showing a schematic construction of an image forming apparatus that is provided with a fixing apparatus according to the present invention;

FIG. 2 is an enlarged longitudinal sectional view of the fixing apparatus according to a first embodiment of the present invention;

FIG. 3 is a flowchart according to the first embodiment of the present invention;

FIG. 4 is an enlarged longitudinal sectional view of the fixing apparatus according to a second embodiment of the present invention;

FIG. 5 shows a relationship between the fixing temperature and the gloss; and

FIG. 6 shows a relationship between the fixing pressure and the gloss.

### DESCRIPTION OF THE PREFERRED EMBODIMENTS

Hereinafter, embodiments of the present invention will be described with reference to the drawings. Those having the same structure or the same operation are denoted by the same reference symbols in the respective drawings.

First Embodiment

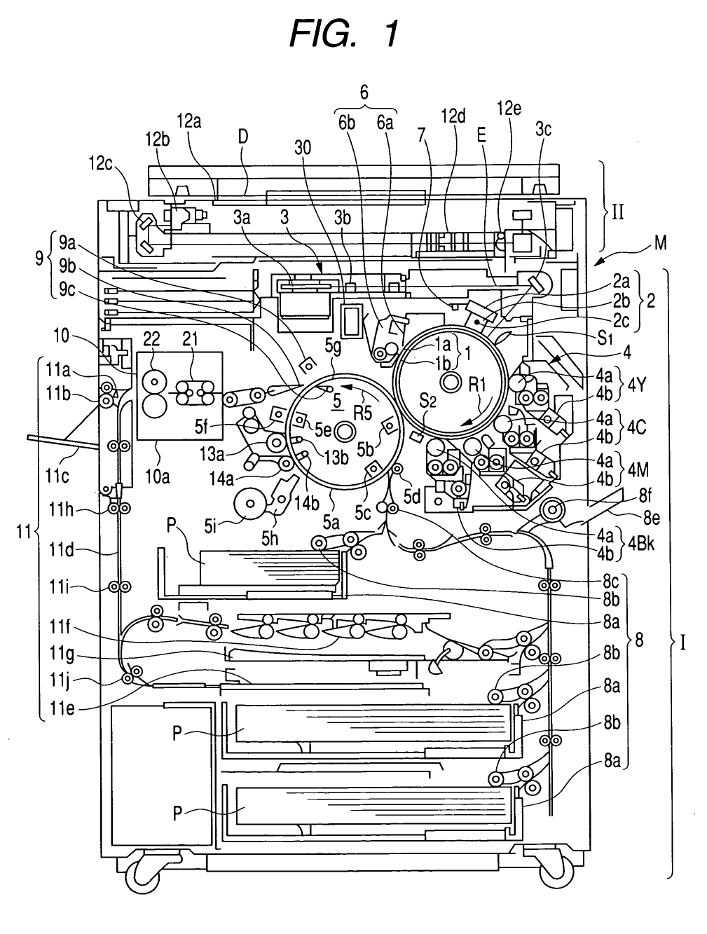

FIG. 1 shows an example of an image forming apparatus (image forming apparatus according to the present invention) that is provided with a fixing apparatus according to the present invention. The image forming apparatus shown in FIG. 1 is a four-color (full color) printer using an electrophotographic process and a digital process (hereinafter referred to as “image forming apparatus”). FIG. 1 is a longitudinal sectional view showing a schematic construction thereof. Note that a recording material is a sheet-like member such as plain paper, coat paper, and a transparent film, on which an image is formed. The recording material is also referred to as a recording sheet, a transfer material, a transfer sheet, a sheet, a sheet material, and the like.

The image forming apparatus shown in FIG. 1 includes a digital color image printer portion (hereinafter simply referred to as “printer portion”) I that is disposed below an image forming apparatus main body (hereinafter referred to as “apparatus main body”) M, and a digital color image reader portion (hereinafter simply referred to as “reader portion”) II that is disposed above the apparatus main body M. The image forming apparatus forms an image on a recording material P in the printer portion I based on an image of an original D read in the reader portion II, for example.

The construction of the printer portion I will be described first, followed by a description of the construction of the reader portion II.

The printer portion I includes a photosensitive drum 1 as an image bearing member that is driven to rotate in a direction indicated by an arrow R1. Disposed around the photosensitive drum 1, along a rotational direction thereof, are a primary charger (charging means) 2, an exposing apparatus (exposing means) 3, a developing apparatus (developing means) 4, a transferring apparatus (transferring means) 5, a cleaning apparatus (cleaning means) 6, a pre-exposure lamp (pre-exposure means) 7, and the like substantially in the stated order. A sheet feeding and conveying portion 8 for the recording material P is disposed below the transferring apparatus 5, that is, in the lower half portion of the printer portion I. Further, a separating apparatus (separating means) 9 is disposed above the transferring apparatus 5, and a fixing apparatus (fixing means) 10 and a discharging portion 11 are disposed on a downstream side of the separating apparatus 9 (on a downstream side in a conveying direction of the recording material P: on the left side of the separating means 9 in FIG. 1).

The photosensitive drum 1 is provided with an aluminum drum-like base member 1a and an organic photoconductive (OPC) layer 1b covering a surface (circumferential surface) of the base members 1a, and is driven to rotate at a predetermined process speed (circumferential speed) in the direction indicated by the arrow R1 by a driving means (not shown). Note that the photosensitive drum 1 will be described later.

The primary charger 2 is a corona charger and includes a shield 2a having an opening at a portion facing the photosensitive drum 1, an electric discharge wire 2b disposed inside the shield 2a in parallel with the generating line of the photosensitive drum 1, and a grid 2c that is disposed at the opening of the shield 2a and regulates a charged potential. A charging bias is applied to the primary charger 2 by a power source for applying a voltage, thereby uniformly (evenly) charging a surface of the photosensitive drum 1 to predetermined polarity and potential.

The exposing apparatus 3 includes a laser output portion from which a laser beam is emitted based on an image signal from the reader portion II that will be described later, a polygon mirror 3a that reflects the laser beam, a lens 3b, and a mirror 3c. With the exposing apparatus 3, the laser beam is applied to the surface of the photosensitive drum 1, exposing the surface of the uniformly charged photosensitive drum 1 to the laser beam, and an electrical charge at the exposed portion is removed to form an electrostatic latent image. In this embodiment, the electrostatic latent image is formed on the surface of the photosensitive drum 1 based on the image of the original D by laser beams separated into four colors of yellow, cyan, magenta, and black. Thus, electrostatic latent images corresponding to respective colors are successively formed.

The developing apparatus 4 includes four developing devices 4Y, 4C, 4M, and 4Bk disposed in the stated order along the rotational direction of the photosensitive drum 1 (the direction indicated by the arrow R1) from an upstream side. The developing devices 4Y, 4C, 4M, and 4Bk contain toner (developer) of respective colors of yellow, cyan, magenta, and black, mainly composed of resin. The developing devices 4Y, 4C, 4M, and 4Bk each have a developing sleeve 4a for adhering toner to the electrostatic latent image formed on the surface of the photosensitive drum 1. One developing device that contains the toner of the color to be used for developing the electrostatic latent image on the photosensitive drum 1 is selected at a time and brought to a developing position in the vicinity of the surface of the photosensitive drum 1 by an eccentric cam 4b. The toner is adhered to the electrostatic latent image through the developing sleeve 4a to form a toner image (visible image) as a visualized image. The developing devices containing the toners of the other three colors, which are not used for development, are retracted from the developing position.

The transferring apparatus 5 includes a transferring drum (recording material carrying member) 5a for carrying the recording material P on its surface, a transfer charger 5b for transferring the toner image on the photosensitive drum 1 onto the recording material P, an attracting charger 5c for attracting the recording material P to the transferring drum 5a, an attracting roller 5d that is opposed to the attracting charger 5c, an inside charger 5e, and an outside charger 5f. The transferring drum 5a is rotatably supported to be driven to rotate in a direction indicated by an arrow R5. A recording material carrying sheet 5g composed of a dielectric member is cylindrically and integrally provided under tension over the opening area in the circumferential surface of the transferring drum 5a. A dielectric sheet such as a polycarbonate film is used for the recording material carrying sheet 5g. Further, a cam and cam follower (contacting and separating member) 5h for bringing the transferring drum 5a into contact with or away from the photosensitive drum 1 is disposed obliquely below the transferring drum 5a in FIG. 1. When the toner image on the photosensitive drum 1 is not being transferred onto the recording material P on the transferring drum 5a, the cam and cam follower 5h keeps the transferring drum 5a spaced away from the surface of the photosensitive drum 1. The transferring apparatus 5 serves to attract and carry the recording material P on the surface of the transferring drum 5a, and separate the recording material P from the transferring drum 5a after the toner image is transferred onto the recording material P.

The cleaning apparatus 6 includes a cleaning blade 6a for scraping off toner (residual toner) that has not been transferred onto the recording material P and remains on the surface of the photosensitive drum 1, and a cleaning container 6b for collecting the scraped toner.

The pre-exposure lamp 7 is disposed on an upstream side of the primary charger 2 along the rotational direction of the photosensitive drum 1, adjoining the primary charger 2. The pre-exposure lamp 7 removes an unnecessary electrical charge from the surface of the photosensitive drum 1 that has been cleaned by the cleaning apparatus 6.

The sheet feeding and conveying portion 8 includes plural sheet feeding cassettes 8a for stacking and storing recording materials P of different sizes, a sheet feeding roller 8b for feeding the recording material P stored in the sheet feeding cassettes 8a, plural conveying rollers, a registration roller 8c, and the like. The sheet feeding and conveying portion 8 supplies to the transferring drum 5a the recording material P having a predetermined size. A manual feed tray 8e is provided on the right hand side surface of the apparatus main body M (the right hand side surface in FIG. 1). The recording material P that is set on the manual feed tray 8e is fed to the registration roller 8c by a sheet feeding roller 8f.

The separating apparatus 9 includes a separation charger 9a, a separation claw 9b, a separation pushup roller 9c, and the like. The separating apparatus 9 serves to separate the recording material P from the transferring drum 5a to which the toner image has been transferred.

The fixing apparatus 10 includes a first fixing means 21 and a second fixing means 22 provided inside a frame member 10a. The fixing means 21 is a fixing means disposed on an upstream side in the conveying direction of the recording material. The second fixing means 22 is disposed on a downstream side of the first fixing means 21. The fixing apparatus 10 will be described in detail later. Note that although the first fixing means and the second fixing means are provided inside one frame member in this embodiment, the first fixing means and the second fixing means may be provided in separate frame members.

The discharging portion 11 includes a conveying path switching guide 11a, a discharging roller 11b, a discharging tray 11c, and the like that are disposed on a downstream side of the fixing apparatus 10 along the conveying direction of the recording material P. Further, disposed under the conveying path switching guide 11a are a vertical conveying path 11d, a reversing path 11e, a stacking member 11f, an intermediate tray 11g, conveying rollers 11h and 11i, a reversing roller 11j, and the like for forming images on both sides of one recording material P.

Further, an electrical potential sensor S₁ for detecting a charged potential of the surface of the photosensitive drum 1 is disposed around the photosensitive drum 1 and between the primary charger 2 and the developing apparatus 4. A density sensor S₂ for detecting a density of the toner image on the photosensitive drum 1 is disposed between the developing apparatus 4 and the transferring drum 5a.

The reader portion II will be explained next. The reader portion II is disposed above the printer portion I, and includes an original table glass 12a on which the original D is placed, an exposing lamp 12b for performing exposure and scanning on an image-formation surface of the original D while moving, plural mirrors 12c for further reflecting reflected light from the original D, a lens 12d for condensing the reflected light, a full color sensor 12e for forming a color separation image signal based on the light from the lens 12d, and the like. The color separation image signal is processed by a video processing unit (not shown) via an amplifying circuit to be output to the printer portion I described above.

Next, operations of the image forming apparatus having the construction described above will be briefly described by adding some more structures. Note that in the following description, it is assumed that a four-color (full color) image is formed in the order of yellow, cyan, magenta, and black.

The image of the original D mounted on the original table glass 12a of the reader portion II is irradiated with light by the exposing lamp 12b, and subjected to color separation. A yellow image is first read by the full color sensor 12e, and after undergoing a predetermined process, transmitted to the printer portion I as an image signal.

On the other hand, in the printer portion I, the photosensitive drum 1 is driven to rotate in the direction indicated by the arrow R1, and the primary charger 2 uniformly charges the surface of the photosensitive drum 1 to predetermined polarity and potential. A laser beam is emitted from the laser output portion of the exposing apparatus 3 based on the image signal from the reader portion II described above. The already charged surface of the photosensitive drum 1 is exposed to an optical image E through the polygon mirror 3a and the like. An electrical charge is removed from the exposed portion of the surface of the photosensitive drum 1, and an electrostatic image corresponding to yellow is formed. As for the developing apparatus 4, the developing device 4Y for yellow is disposed at the predetermined developing position, and the other developing devices 4C, 4M, and 4Bk are retracted from the developing position. The developing device 4Y applies yellow toner to the electrostatic image on the photosensitive drum 1, and the electrostatic image is visualized to be a toner image. The yellow toner image on the photosensitive drum 1 is transferred onto the recording material P carried on the transferring drum 5a. Note that the recording material P is one with a suitable size for the original image, and has been supplied from a predetermined one of the sheet feeding cassettes 8a to the transferring drum 5a via the sheet feeding roller 8b, conveying rollers, the registration roller 8c, and the like at predetermined timing. The recording material P thus supplied is attracted to be wound around the surface of the transferring drum 5a and rotated in the direction indicated by the arrow R5, and the yellow toner image on the photosensitive drum 1 is transferred to the recording material P by the transfer charger 5b.

On the other hand, the cleaning device 6 removes residual toner on the surface of the photosensitive drum 1 to which the toner image has been transferred, and the pre-exposure lamp 7 removes the unnecessary electrical charge. Then the photosensitive drum 1 is ready for the next image formation starting with the primary charger 2.

The respective processes described above, from the reading of the image of the original by the reader portion II, through the transferring of the toner image onto the recording material P on the transferring drum 5a, to the cleaning of the photosensitive drum 1 and the removal of the electrical charge therefrom, are performed for the colors other than yellow, that is, cyan, magenta, and black. Then the toner images of four colors are transferred onto the recording material P on the transferring drum 5a, superposing each other.

The recording material P onto which the toner images of four colors are transferred, is separated from the transferring drum 5a by the separation charger 9a, the separation claw 9b, and the like, and is conveyed to the fixing apparatus 10 while bearing an unfixed toner image T on the surface thereon. The recording material P is heated and pressurized by the fixing apparatus 10, and the toner image on the surface thereof is fused and fixed. The recording material P onto which the toner image has been fixed is delivered to the delivery tray 11c by the discharging roller 11b. Note that if images are to be formed on both sides of the recording material P, the conveying path switching guide 11a is driven immediately after the toner image is transferred. The recording material P with the image fixed is introduced first to the reversing path 11e via the vertical conveying path 11d, and is moved to leave the reversing path 11e in a direction opposite to the direction in which it has been introduced, with the trailing edge of the recording material P as it was first introduced becoming the leading edge by the reverse rotation of the reversing roller 11j. Then the recording material P is received by the intermediate tray 11g. After that, an image is formed on the other surface by performing the above image forming processes again, and the recording material P is delivered onto the discharging tray 11c.

The transferring drum 5a after the separation of the recording material P is cleaned in order to prevent scattering of powder, adhering of oil on the recording material P, onto the recording material carrying sheet 5g, and so on. The cleaning is performed by using a fur brush 13a and a backup brush 13b that are opposed each other with the recording material carrying sheet 5g therebetween, and an oil removing roller 14a and a backup brush 14b that are opposed to each other with the recording material carrying sheet 5g therebetween. The cleaning is performed before or after image formation, and whenever jam (sheet jam) occurs.

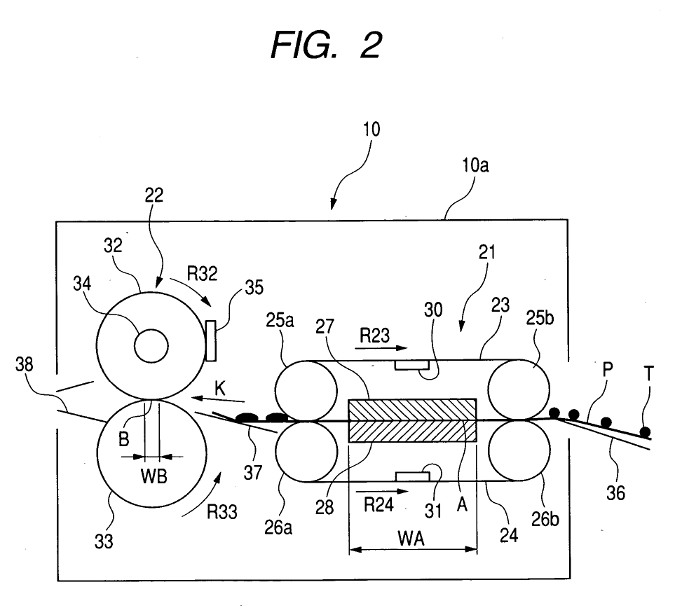

Next, referring to FIG. 2, an example of the fixing apparatus 10 according to the present invention will be described. FIG. 2 is an enlarged view of the fixing apparatus 10 of FIG. 1.

As shown in FIG. 2, the fixing apparatus 10 includes the frame member 10a. Provided inside the frame member 10a are the two fixing means, the first fixing means 21 disposed on the upstream side in the conveying direction of the recording material, and the second fixing means 22 disposed on the downstream side of the first fixing means 21 in the conveying direction of the recording material.

The first fixing means 21 will be described first.

The first fixing means 21 includes a fixing belt 23 as a heating member and a pressure belt 24 as a belt. The fixing belt 23 functions as a fixing member that comes into contact with the image (toner image) on the recording material and fixes the image to the recording material. The fixing belt 23 is formed by providing a silicone rubber as an elastic layer around the outer circumference of a nickel belt, with a PFA tube as a release layer being further provided on a surface thereof. The nickel belt is approximately 94 mm long and 50 μm thick, the silicone rubber is 500 μm thick, and the PFA tube is 30 μm thick. A similar belt is used for the pressure belt 24. The fixing belt 23 is looped around two belt rotation shafts 25a and 25b under tension, and the pressure belt 24 is looped around two belt rotation shafts 26a and 26b under tension. The fixing belt 23 and the pressure belt 24 are rotated in the direction indicated by an arrow R23 and in the direction indicated by an arrow R24 without slipping from the belt rotation shafts 25a and 25b and from the belt rotation shafts 26a and 26b, respectively. The belt rotation shafts 25a, 25b, 26a, and 26b are each formed by covering a circumferential surface of an aluminum cored bar with a sponge of foamed silicone rubber. The belt rotation shaft 25a and the belt rotation shaft 26a are pressurized with a gross load of 5 kgf (49 N). Similarly, the belt rotation shaft 25b and the belt rotation shaft 26b are pressurized with a gross load of 5 kgf (49 N).

An exciting coil (heat source) 27 as a belt heating source is disposed between the two belt rotation shafts 25a and 25b inside the fixing belt 23. Similarly, an exciting coil (heat source) 28 as a belt heating source that generates a magnetic field is disposed between the two belt rotation shafts 26a and 26b inside the pressure belt 24. The exciting coils 27 and 28 are flat and formed by molding an insulating resin. The exciting coils 27 and 28 pressurize each other with a gross load of 20 kgf (196 N). In this embodiment, the exciting coil 28 as a first pressure member comes into press contact with the fixing belt as a fixing member. With this construction, a width (width in the conveying direction of the recording material P) WA of a nip portion A between the fixing belt 23 and the pressure belt 24, which is a first nip portion, is approximately 30 mm. The gross load between the fixing belt 23 and the pressure belt 24 is 30 kgf. Therefore, the linear pressure is approximately 1 kgf (9.8 N)/mm.

The linear pressure described here can be calculated by dividing the gross load (kgf) between the heating member and the pressure member by the width (mm) of the entire contact portion between the heating member and the pressure member. Note that the fixing belt 23, the pressure belt 24, the belt rotation shafts 25a, 25b, 26a, and 26b, and the exciting coils 27 and 28 described above each have a length in a paper passing width direction of the recording material P (a direction perpendicular to the conveying direction of the recording material P) larger than the paper passing width of the recording material P having the largest paper passing width to be subjected to image formation.

A high frequency current (frequency of 20 kHz, and current of 20 A, for example) flows in the exciting coils 27 and 28 described above, and the exciting coils 27 and 28 are heated by an eddy current generated in the conductive layer of the fixing belt 23 and the pressure belt 24 due to a magnetic field. The exciting coils 27 and 28 are controlled so as to have a constant temperature of 130° C., which is a target temperature of the fixing belt 23 and the pressure belt 24, based on values detected by temperature sensors 30 and 31 as a temperature detection member. Hereupon, the temperature control will be explained. The temperature control is for controlling an amount of power supply to the exciting coil on the basis of output of the temperature sensor so as to become the set temperature by a first power supply means such as a triac.

The fixing belt 23 and the pressure belt 24 are driven to rotate in the direction indicated by the arrow R23 and in the direction indicated by the arrow R24, respectively, by the driving means at least when image formation is performed. The fixing belt 23 and the pressure belt 24 are rotated without causing a wrinkle at a predetermined circumferential speed, which is substantially the same as a conveying speed of the recording material P bearing the unfixed toner image T which is conveyed from the image transferring portion side (transferring drum 5a side). In this embodiment, the fixing belt 23 and the pressure belt 24 are rotated at a circumferential speed of 250 mm/sec, enable fixing of a full color image on 60 A4-sized sheets per minute.

Further, when the temperature of the fixing belt 23 and the pressure belt 24 is controlled so as to become a predetermined fixing temperature, the recording material P bearing the unfixed toner image T is introduced to the press contact portion A between the fixing belt 23 and the pressure belt 24, with its toner image bearing surface facing the fixing belt 23. The recording material P comes into close contact with a circumferential surface of the fixing belt 23 at the press contact portion A, nipped and conveyed at the nip portion A together with the fixing belt 23. The heat of the fixing belt 23 and the heat of the pressure belt 24 are applied to the recording material P, and the pressuring force of the nip portion A is applied thereto. Thus the unfixed toner image T is fixed to the surface of the recording material P under heat and pressure. The recording material P, after passing through the nip portion A, is separated from the circumferential surface of the fixing belt 23, and conveyed to the second fixing means 22.

The fixing belt 23 and the pressure belt 24, which are rotated, are pressurized with a relatively light pressure, and therefore a shifting force in a width direction (direction along the belt rotation shafts 25a, 25b, 26a, and 26b) is small even during rotation. That is, the force for moving the fixing belt 23 and the pressure belt 24 in the width direction is small. Accordingly, it is sufficient to provide, as a means for regulating the shift of the belts in the width direction, a flange member that simply receives edge portions of the fixing belt 23 and the pressure belt 24. This is advantageous because the construction of the first fixing means 21 can be made simple. It is also possible to adopt a modified construction in which heating members are provided inside the belt rotation shafts 25a, 25b, 26a, and 26b.

The second fixing means 22 will be described next.

The second fixing means 22 includes a fixing roller 32 as an image heating member and a pressure roller 33 as a second pressure member. The fixing roller 32 serves to heat the image on the recording material and fix the image to the recording material. The fixing roller 32 is formed by coating an iron cylindrical cored bar with a silicone rubber as an elastic layer, with a PFA tube as a release layer being further provided on a surface thereof. The cylindrical cored bar is 30 mm long and 1 mm thick, the silicone rubber is 1 mm thick, and the PFA tube is 30 μm thick. The construction of the surface of the pressure roller 33 is similar to that of the fixing roller 32. Although the similar construction is adopted in this embodiment, it is more preferable that the release layer of the image heating member of the second fixing means exhibit higher releasing property than that of the fixing member of the first fixing means in order to obtain a high gloss. The fixing roller 32 and the pressure roller 33 are pressurized with a gross load of 45 kgf (441 N). A width (width along the conveying direction of the recording material P) WB of a nip portion B between the fixing roller 32 and the pressure roller 33, which is a second nip portion, is approximately 3 mm. Accordingly, the linear pressure is approximately 15 kgf/mm (=45 kgf/3 mm).

A halogen heater (heat source) 34 as a heat source is provided inside the fixing roller 32. The halogen heater 34 is controlled so as to be switched ON/OFF based on the value detected by a temperature sensor 35 as a temperature detection member, so that the temperature of the fixing roller 32 becomes 100° C., which is a target temperature. Hereupon, the temperature control will be explained. The temperature control is for controlling an amount of power supply to the halogen heater on the basis of output of the temperature sensor so as to become the set temperature by a second power supply means such as a triac.

The fixing roller 32, the pressure roller 33, and the halogen heater 34 each have a width longer than the paper passing width of the recording material P. The fixing roller 32 and the pressure roller 33 are rotated in a direction indicated by an arrow R32 and in a direction indicated by an arrow R33, respectively, by the driving means at least when image formation is performed. The fixing roller 32 and the pressure roller 33 are rotated at this time at a predetermined circumferential speed, which is substantially the same as the conveying speed of the recording material P bearing the unfixed toner image T which is conveyed from the image transferring portion side (transferring drum 5a side).

Note that, as shown in FIG. 2, guide members 36, 37, and 38 for guiding the conveyance of the recording material P, are provided along the conveying direction of the recording material P (a direction indicated by an arrow K). The guide member 36 is disposed on an upstream side of the first fixing means 21, the guide member 37 is arranged between the first fixing means 21 and the second fixing means 22, and the guide member 38 is arranged on a downstream side of the second fixing means 22.

Here, the characteristics of the fixing apparatus 10 according to this embodiment are as follows: the first fixing means 21 performs fixing under a relatively low temperature, low pressure condition, and for a long period of time (with the width WA of the press contact portion A being wide); and the second fixing means 22 performs fixing under a relatively high pressure condition, and for a short period of time. With the period of time for the recording material to pass through the press contact portion (nip portion) A of the first fixing means 21 being longer than the period of time for the recording material to pass through the press contact portion B of the second fixing means 22, it is possible to obtain a fixed image having a low gloss without making the fixing temperature too high. This is because the gloss given by the first fixing means 21 is low, and the gloss is controlled by the second fixing means 22 to a desirable level. Accordingly, the gloss of the image fixed by the first fixing means 21 can be made as uniform as possible regardless of the thickness and the kind of the recording material P, and of the ambient temperature and humidity. The gloss of the image is controlled by the temperature of the fixing roller 32 of the second fixing means 22. If the temperature of the fixing roller 32 is high, the gloss of the image becomes high. It is necessary here that fixing property be secured at the time of passage through the first fixing means 21.

The level of securing the fixing property is explained here.

An image is fixed such that the amount of toner on the recording material image is 1.5 mg/cm². The following measurement is performed on the image in an environment with a room temperature of 25° C. and a humidity of 60%. First, the recording material on which the toner image is fixed is folded lightly at a position 1 to several centimeters away from the trailing edge thereof. The recording material is creased by using a brass cylinder (60 mm in outer diameter and 40 mm in height) that is slid back and forth on the recording material by 5 times (1 back-and-forth sliding a second). Then the recording material is folded again at a right angle to the above crease to form a cross crease. A brass prism having a side length of 22 mm and a height of 49 mm that is wrapped with a silbon sheet is used to wipe out the toner that has peeled off from the creased portion. After that, the PERSONAL IAS manufactured by Quality Engineering Associates, Inc., is used to measure the amount of toner that has peeled off. The measured area is 3 mm×2.5 mm with the center of the cross being brought to the center of the PERSONAL IAS. As for the measurement method, the recording material with the toner image before folding, and the recording material with no toner image are respectively measured first. Then the toner image after the toner is wiped out by the silbon sheet is measured. As a result, the ratio of the toner peeling can be detected.

As for the level of securing the fixing property, if the ratio of toner peeling is no more than 70%, it is assumed that the fixing property is secured. It is desirable, depending on the thickness of the recording material, that the ratio of peeling be no more than 50%.

More specifically, with plain paper having a basis weight of 80 g, the target temperature of the fixing belt 23 and the pressure belt 24 of the first fixing means 21 on the upstream side is usually 130° C. If the target gloss is low, the target temperature of the fixing roller 32 of the second fixing means 22 on the downstream side is 100° C. At this time, the gloss as measured by a 60° gloss gauge is 10. If a higher gloss is desired, the gloss of 40 can be obtained by setting the target temperature at 180° C.

Further, it is preferable that the target temperature of the fixing belt 23 and the pressure belt 24 of the first fixing means 21 and the target temperature of the fixing roller 32 of the second fixing means 22 be changed as appropriate according to the kind of the recording material P to be used. To change the target temperature, a fixing temperature is set according to the recording material used, with a fixing temperature setting means. For example, when fixing is to be performed cardboard having a basis weight of 150 g, the fixing temperature setting means sets the target temperature of the fixing belt 23 and the pressure belt 24 to 150° C., which is 20° C. higher than that with the plain paper. Normally, fixing on cardboard must be performed at a slower fixing speed in order to maintain the fixing property. However, according to this embodiment, by simply raising the temperature of the first fixing means 21 on the upstream side, it becomes unnecessary to make the fixing speed slower even with cardboard, and it is possible to obtain a low gloss while securing the fixing property when only the fixing in the upstream side is complete. Further, even with such cardboard, the amount of heat supply per unit area does not become excessive because the nip width is large. Therefore, no abnormality occurs due to water vapor even if coat paper is passed.

Further, if the temperature of the fixing roller 32 at the time of fixing by the second fixing means 33 on the downstream side is controlled by the heating temperature setting means, arbitrary control is possible from a low gloss to a high gloss.

For example, when cardboard having a basis weight of 150 g is subjected to fixing, the target temperature of the fixing belt 23 and the pressure belt 24 of the first fixing means 21 on the upstream side is set to 150° C. If the target gloss is low, the target temperature of the fixing roller 32 of the second fixing means 22 on the downstream side is set to 100° C., to thereby obtain the gloss of 10 as measured by the 60° gloss gauge. If the target gloss is high, the target temperature of the fixing roller 32 of the second fixing means 22 on the downstream side is set to 200° C., to thereby obtain the gloss of 40. In this embodiment, the glass transition point of the toner is 90° C. to 100° C. In this embodiment, to obtain an image having a low gloss, the temperature of the fixing roller 32 of the second fixing means 22 is set to a temperature in the vicinity of the glass transition point. Even when the recording material is passed through the second fixing means 22 that is controlled so as to have this temperature, the toner on the recording material is little affected by heat. Therefore, it is possible to suppress to the minimum the increase of the gloss caused by passing the recording material through the second fixing means 22.

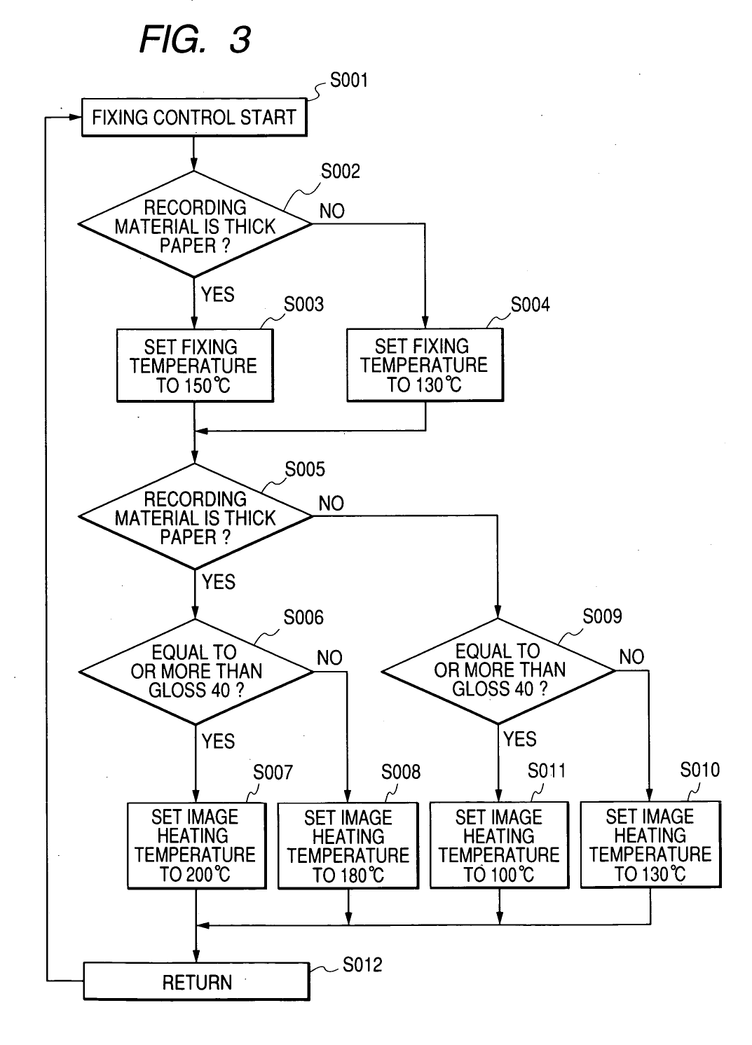

FIG. 3 shows a flowchart of the present invention.

First, when the fixing control is started (S001), detection of whether the recording material is the thick paper is performed (S002). When the recording material is the thick paper, in order to acquire fixing property, the fixing temperature of the temperature of the fixing member is set to 150° C. so as to control power supply to the fixing means (S003). When the recording material is not the thick paper, in order to prevent the image from having a high gloss by the fixing means, the fixing temperature of the temperature of the fixing member is set to 130° C. so as to control power supply to the fixing means (S004). Next, determination of whether the recording material is the thick paper is performed again (S005). At this time, in case where the recording material is the thick paper, detection of whether the set degree of gloss is a high gloss equal to or greater than the gloss of 40 is performed (S006). When the recording material is the thick paper and the set degree of gloss is a high gloss, the image heating temperature is set to 200° C., considering that the recording material greatly deprives the amount of heat (S007). When the set degree of gloss is a high gloss, the image heating temperature is set to 180° C. (S008). Further, when the recording material is not the thick paper, the image heating temperature is again changed in accordance with the set degree of gloss. Namely, when the set degree of gloss is a high gloss the image heating temperature is set to 130° C. (S010), and when the set degree of gloss is a low gloss the image heating temperature is set to 100° C. (S011). The reason is for preventing the high temperature offset arising by excessively heating. After that, the temperature is controlled at each of the set temperatures. Subsequently, the same control as mentioned above is repeated (S012).

In this embodiment, the target gloss may be selected in a selection portion from a high gloss, a normal gloss, and a low gloss. It is also possible to input the target gloss by a number. Further, the target gloss may be selected, based on the output from a gloss detection means for detecting the gloss of the recording material, such that the target gloss may approach the gloss of the recording material.

Further, as for the conveying speed of the recording material P that passes through the fixing devices, the conveying speed at which the recording material P passes through the first fixing means 21 is not different from, but is substantially the same as the conveying speed at which the recording material P passes through the second fixing means 22. Therefore, there is no decrease in productivity depending on the gloss, and it is possible to obtain fixed images having a wide range of glosses.

Further, the temperature of the fixing roller 32 may be controlled so as to change according to the ambient temperature and humidity. In this case, it is possible to obtain an image having a target gloss regardless of the ambient temperature and humidity.

Note that the control of the pressuring force of the second fixing means 22, and the control of the temperature of the fixing belt 23 and the pressure belt 24 of the first fixing means 21 are not limited to the above, and may be changed as appropriate. Further, when coat paper or the like which has low air permeability is used for the recording material P, the moisture in the coat paper is evaporated instantly to make the coating layer on the surface of the coat paper rough if the fixing is performed at a relatively high temperature. However, it is possible to solve this problem with the fixing apparatus 10 according to this embodiment. The first fixing means 21 is controlled so as to have a relatively low temperature (130° C. in this embodiment) to thereby prevent the coating layer of the coat paper from becoming rough due to water vapor. Because the fixing is once performed by the first fixing means 21, the moisture of the paper is greatly reduced by the time immediately before the fixing by the second fixing means 22. Therefore, even if fixing is performed at a high temperature by the second fixing means, the coating layer does not easily become rough. Further, because the width WA of the press contact portion WA is large, though the fixing temperature is relatively low, the first fixing means 21 can heat the toner image on the recording material P for a long period of time. Therefore, the fixing strength can be maintained.

As in the fixing apparatus 10 described above, if at least one (both, however, in this embodiment) of the heating member and the pressure member of the first fixing means 21 is configured by a belt, it is easier to increase a period of time for applying treatments on the unfixed toner image T and the recording material P compared to a case where the heating member and the pressure member are constructed by rollers. Further, if at least the heating member of the second fixing means 22 (both the heating member and pressure member in this embodiment) is constructed by a roller, it is possible to make the linear pressure at the press contact portion B high compared to a case where the heating member and the pressure member are constructed by belts.

Further, in this embodiment, when a low gloss is to be obtained, power supply to the second fixing means may be cut off. Further, a fixed image may be output without passing the recording material through the second fixing means when a low gloss is to be obtained.

Second Embodiment

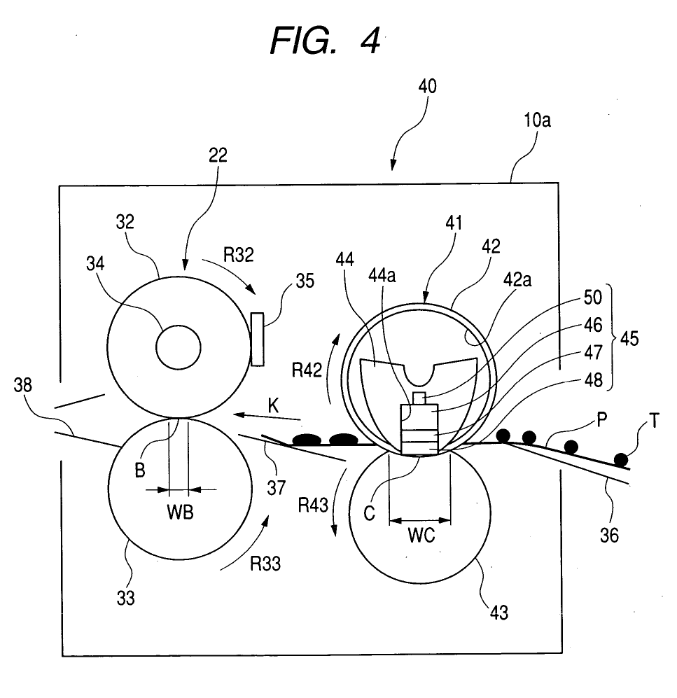

FIG. 4 shows another example of the fixing apparatus according the present invention, that is, a fixing apparatus 40 according to a second embodiment of the present invention. FIG. 4 is one that corresponds to FIG. 2, that is, an enlarged longitudinal sectional view thereof.

The fixing apparatus 40 includes a first fixing mean 41 and the second fixing means 22 as shown in FIG. 4. Of those, the second fixing means 22 is the same as the second fixing means 22 of FIG. 2 according to the first embodiment, and therefore the description thereof is omitted. The first fixing means 41 will be explained below.

The first fixing means 41 includes a fixing film 42 as a fixing member and an elastic pressure roller 42 as a first pressure member. A film guide member (stay) 44 and a heating member 45 held by the film guide 44 are provided inside the fixing film 42. The fixing film 42, the elastic pressure roller 43, the film guide member 44, and the heating member 45 are all made longer than the paper passing width of the recording material P.

As shown in FIG. 4, the film guide member 44 has a substantially semi-arcuate, gutter section, and a holding groove 44a is formed at a lower portion thereof along a longitudinal direction. A heating member 45 described below is mounted to the holding groove 44a. The film guide member 44 is formed by molding a heat resistant resin such as poly phenylene sulfide (PPS) or a crystalline polymer.

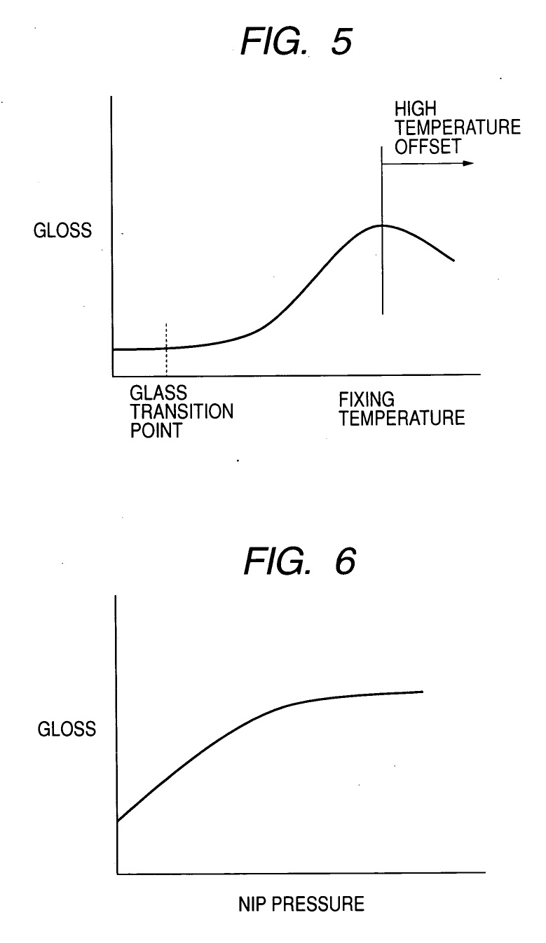

The heating member 45 is a ceramic heater having small heat capacity as a whole. The heating member 45 includes a thin, long alumina heater substrate 46, and a linear or thin-band shaped heating member 47 of Ag/Pb, or the like, formed on the surface side of the heating member 45 (a sliding surface side of the film: lower side surface in FIG. 4) along a longitudinal direction. The heating member also includes a thin surface protection layer 48 such as a glass layer, a thermistor 50 as a temperature detection member that is disposed on the rear side of the heater substrate 46 (upper surface side in FIG. 5), and the like. The heating member 45 is quickly heated through supply of power to the heating member 47, and controlled so as to become a predetermined target temperature of 150° C. by the power control system including the thermistor 50.

The fixing film 42 as a fixing member is formed of an endless heat resistant film and is loosely fit to the film guide member 44. To make the heat capacity of the fixing film 42 small and to improve quick starting property of the fixing apparatus 40, the fixing film 42 has a total thickness of no more than 100 μm, preferably no more than 60 μm and no less than 20 μm, and has heat resistance, releasing property, strength, durability, and the like. The fixing film may be a single layer film of polytetrafluoroethylene (PTFE), tetrafluoroethylene-perfluoroalkylvinylether (PFA), PPS, and the like. Alternatively, the fixing film 42 may be a composite layered film and the like formed by coating a surface of a base film of polyimide, polyamideimide, polyetheretherketone (PEEK), polyethersulfone (PES), and the like with PTFE, PFA, and the like as a release layer. For use in a full color, thermal-fixing apparatus, a heat resistant elastic layer made of a silicone rubber or the like may be provided between the base film and the release layer although the quick starting property is sacrificed to some degree. By providing the elastic layer, the toner on the recording material P can be fused while being covered with the surface of the fixing film 42, thus securing the fixing property.

The elastic pressure roller 43 is a pressurizing means for pressing the fixing film 42 against the heating member 45 from below, allowing the fixing film 42 to be nipped between the heating member 45 and itself. At this time, the elastic pressure roller 43 is elastically deformed and a press contact portion C (contact portion between the fixing film 42 and the elastic pressure roller 43), which is a first nip portion, is formed between the fixing film 42 and the elastic pressure roller 43. A width WC of the press contact portion C is approximately 8 mm. Further, the gross pressure of the elastic pressure roller 43 is approximately 16 kgf, and therefore the linear pressure at the press contact portion C is 2 kgf/mm. The elastic pressure roller 43 is driven to rotate in a direction indicated by an arrow R43 at a predetermined circumferential speed by a drive force of a driving means transmitted through a power transmission mechanism such as a gear.

The fixing film 42 is rotated in a direction indicated by an arrow R42, following the rotation of the pressure roller 43 in the direction indicated by the arrow R43 at least when the image formation is performed. That is, when the elastic pressure roller 43 is rotated in the direction indicated by the arrow R43, a rotation force acts at the press contact portion C due to a friction force with the elastic pressure roller 43, and the fixing roller 42 is rotated without causing a wrinkle in the direction indicated by the arrow R42 at a predetermined circumferential speed, with an inner circumferential surface 42a of the fixing roller 42 in contact with a surface (lower surface in FIG. 4) of the heating member 45. The predetermined circumferential speed is substantially the same as the conveying speed of the recording material P bearing the unfixed toner image T which is conveyed from the image transferring portion side (transferring drum 5a side). In this embodiment, the fixing roller 42 is rotated at a circumferential speed of 130 mm/sec, enabling fixing of a full color image on 32 A4-sized sheets per minute. In this case, a lubricant such as heat resistant grease may be interposed between the inner circumferential surface 42a of the fixing film 42 and the surface of the fixing member 45 on which the inner circumferential surface 42a is slid so as to reduce slide contact resistance therebetween In the fixing apparatus 40 having the structure as described above, the fixing film 42 is rotated by the rotation of the elastic pressure roller 43. Further, when the temperature of the heating member 45 is controlled so as to become a predetermined fixing temperature, the recording material as a material to be heated bearing the unfixed toner image T is introduced to the press contact portion C between the elastic pressure roller 43 and the fixing film 42, with its toner image bearing surface facing the fixing film 42. The recording material P comes into close contact with (a circumferential surface of) the fixing film 42 at the press contact portion C, and nipped and conveyed at the press contact portion C together with the fixing film 42. At this time, the heat of the heating member 45 is applied to the unfixed toner image T on the recording material P via the fixing film 42, and the pressuring force of the nip portion C is applied thereto. Thus the unfixed toner image T is thermally press fixed to the surface of the recording material P. After passing through the nip portion C, the recording material P is separated from the circumferential surface of the fixing film 42, and conveyed to the second fixing means 22.

Substantially no tension is importioned to the fixing film 42 that is rotated, except at the press contact portion C, and therefore a shifting force in a paper passing width direction is small during rotation of the fixing film 42. That is, the force for moving the fixing film 42 in the width direction with respect to the film guide member 44 is small. Accordingly, it is sufficient to provide, as a means for regulating the shift of the fixing film 42, a flange member that simply receives an edge portion of the fixing film 42. This is advantageous because the construction of the fixing apparatus 40 can be made simple.

In the fixing means 41 of a film-heating type of this embodiment, the heating member 45 having small heat capacity whose temperature rises quickly can be used. It is thus possible to greatly reduce the time period required to heat the fixing means 41 to a predetermined temperature. The temperature can be easily raised even from a normal temperature. Accordingly, stand-by temperature control is unnecessary for the image forming apparatus in a stand-by state when printing is not performed, achieving power saving.

With this kind of fixing means, the same control as that described in the first embodiment is performed to thereby achieve the same effects.

The fixing means according to this embodiment brings about the same effects as those of the first embodiment. In addition, the fixing means according to this embodiment is suitable for use in an image forming apparatus that operates at a relatively slow speed. Accordingly, a significant power saving can be realized.

Note that in the above description, a four-color (full color) image forming apparatus using an electrophotographic process and a digital process is taken as an example of the image forming apparatus provided with the fixing apparatus 10, 40 according to the present invention. However, the image forming apparatus is not limited thereto. That is, the fixing apparatus 10, 40 according to the present invention can be similarly applied to various kinds of image forming apparatus in which a toner image is formed on a recording medium, for example, an image forming apparatus using an electrostatic recording process as well as an electrophotographic process, an image forming apparatus of an analog process as well as a digital process, and an image forming apparatus for white and black printing as well as four-color (full color) printing.

Further, in the fixing apparatus 10, 40, the first fixing means 21, 41 and the second fixing means 22 are contained inside one frame member 10a to form an integrated unit in the first and second embodiments described above. However, it is possible to omit the frame member 10a, and provide the first fixing means 21, 41 and the second fixing means 22 separately in the image forming apparatus main body M.

As described above, according to the present invention, fixing property is secured with respect to various kinds of recording materials by using the fixing means, and the gloss is controlled by the image heating means located on the downstream side of the fixing means in the conveying direction. Accordingly, it is possible to output a wide range of gloss from a low gloss to a high gloss.

While the embodiments of the present invention are described above, the present invention is not limited thereto, and various changes may be made within the technical idea of the present invention.

This application claims priority from Japanese Patent Application No. 2003-205153 filed on Jul. 31, 2003, which is hereby incorporated by reference herein.

1. An image heating apparatus, comprising:
a fixing member for heat-fixing an unfixed toner image on a recording material;
a first pressure member that is brought into press contact with the fixing member and forms a first nip portion where the recording material is nipped and conveyed;
a fixing temperature changing means for changing a fixing temperature of the fixing member in accordance with the recording material;
first power supply control means for controlling the fixing temperature of said fixing member so as to become the changed fixing temperature;
an image heating member for heating an image on the recording material, the image heating member being located on a downstream side of the fixing member in a conveying direction of the recording material;
a second pressure member that is brought into press contact with the image heating member and forms a second nip portion where the recording material is nipped and conveyed, wherein a width of the first nip portion in the conveying direction of the recording material is larger than that of the second nip portion;
a heating temperature changing means for changing a heating temperature of the image heating member in accordance with a predetermined gloss of an image; and
second power supply control means for controlling the heating temperature of the image heating member so as to become the changed heating temperature.

2. An image heating apparatus according to claim 1, wherein a change range of said changeable heating temperature is larger than a change range of said changeable fixing temperature.

3. An image heating apparatus according to claim 1, wherein said heating temperature is set to a temperature higher than said fixing temperature.

4. An image heating apparatus according to claim 1, wherein the gloss is controlled by a set heating temperature of the image heating member.

5. An image heating apparatus according to claim 1, wherein the heating temperature setting means sets the heating temperature according to the recording material.

6. An image heating apparatus according to claim 1, wherein the fixing temperature setting means sets a high fixing temperature when the recording material is thick.

7. An image heating apparatus according to claim 1, wherein the heating temperature setting means sets a high heating temperature when the target gloss of the image is high.

8. An image heating apparatus according to claim 1, wherein the image heating member comprises a release layer on its surface.

9. An image heating apparatus according to claim 1, further comprising a belt that rotates as the fixing member rotates, wherein the first pressure member comes into press contact with the fixing member through the belt.
